(19) United States
(12) Patent Application Publication
(10) Pub. No.: US 2025/0100439 A1
(43) Pub. Date: Mar. 27, 2025

(54) Luggage Ring Assembly

(71) Applicant: Illinois Tool Works Inc., Glenview, IL (US)

(72) Inventor: Ismael FUENTES DOMINGO, Sabadell (ES)

(21) Appl. No.: 18/895,725

(22) Filed: Sep. 25, 2024

(30) Foreign Application Priority Data
Sep. 26, 2023 (EP) 23382974.6
Sep. 10, 2024 (DE) 10 2024 125 994.9

(51) Int. Cl. B60P 7/08

(52) U.S. Cl. CPC B60P 7/0807

(57) ABSTRACT

A luggage ring assembly is disclosed that, in some examples, includes a concealable mounting member and a ring member. The mounting member is adapted to operably engage with a back surface of a panel through at least one aperture. The at least one aperture adapted to receive said mounting member.

### RELATED APPLICATIONS

The present application claims the benefit of European Patent Application No. 23382974.6, filed Sep. 26, 2023, and German Patent Application No. 10 2024 125 994.9, filed Sep. 10, 2024, each titled “Luggage Ring Assembly,” the contents of which are hereby incorporated by reference.

### BACKGROUND

Luggage rings are provided in vehicles to provide convenient attachment points for securing loads within the vehicle. Such luggage ring assemblies can be time consuming to install, often involving a number of separate parts which an operative is required to hold in place and then attach using tools, adhesives, or welding.

While the utility of luggage ring assemblies is useful to the end user of the vehicle, such luggage ring assemblies are often considered unsightly, particularly the mounting member which provides no function to the end user other than as a visual distraction.

### SUMMARY

The present disclosure relates generally to a luggage ring assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 shows (a) an illustration of an example aspect of a luggage ring assembly 101 (a) before installation, (b) during installation with a bolt and (c) in situ, i.e. installed with a suitable panel 104/plate structure (e.g. a car chassis).

FIG. 2 shows a schematic illustration of the individual steps during installation, e.g. on a vehicle chassis, with the steps of (1) insertion of the mounting member 102 through a suitable aperture 105 in the panel 104 of the chassis or structure, (2) rotation of the mounting member 102 into planar contact engagement with the chassis or structure panel 104, (3) positioning (sliding) the a proximal end of the luggage ring assembly 101 under the panel 104 and align the thread member for fastening or fixation 106, and (4) fastening or securing the luggage ring assembly 101 with a suitable bolt or screw via the thread member (nut) provided at the mounting member 102.

FIG. 3 illustrates detailed perspective views of the luggage ring assembly 101 (a) before and (b) after installation with a bolt.

FIG. 4 illustrates an alternative luggage ring assembly.

FIG. 5 illustrates a cross-sectional view of the alternative luggage ring assembly of FIG. 4.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure relates to a luggage ring assembly. Specifically, to luggage ring assemblies. In particular, the disclosure relates to a luggage ring with concealed or hidden attachment means and improved pulling strength.

According to a first aspect of the disclosure there is provided a luggage ring assembly comprising a concealable mounting member and a ring member, wherein said mounting member is adapted to operably engage with a back surface of a panel through at least one aperture, adapted to receive said mounting member. As the mounting member is concealable the necessary, but visually unappealing, mounting member may be hidden from view from the end vehicle user, but still perform the required function (to secure the ring member to the panel). This is achieved through engagement of the mounting member to the back surface of the panel. The back surface is the surface of the panel which is not visible to the end user once the panel is installed. The back surface is accessed by the mounting member via an aperture sized to receive the mounting member or a portion thereof. The aperture is located in the panel.

Suitably, the mounting member is formed in a single piece. In this way an operative does not need to construct or arrange multiple parts in space relative to one another to apply the mounting member to the panel. Likewise, the luggage ring assembly may be provided as a single assembled unit to provide the same advantages. A single piece construction also avoids the creation of potentially weak joints or other points of failure.

Preferably, the mounting member is formed from a pressed material. The mounting member may be formed in a small number of manufacturing steps by pressing the mounting member from a material, such as metal sheet.

Appositely, the ring member is held by the mounting member. The mounting member may, at least in part, capture the ring member, such that the ring member is held in relative proximity to the mounting member and may not disassociate from the mounting member without a determined effort from an end user.

Appropriately, the mounting member comprises a bent portion. The bent portion provides a locating feature to assist in insertion of the mounting member into the aperture by an operative. In use the bent portion is arranged such that a maximum deviation of the bent portion from the main portion of the mounting member is closest to the panel and therefore the aperture, allowing the bent portion to be easily captured by the aperture. Suitably, the bent portion is bent such that the bent portion stands proud of the back face of the mounting member.

Suitably, the bent portion is arranged remote from the ring member. Arranging the bent portion remote from the ring member means an installation operative may grasp the ring member as a handle to guide the mounting member into place via the bent portion.

Preferably, the ring member is held by the mounting member between opposing ends of the mounting member. This does not mean that the ring member is held by the opposing ends. This means that the ring member is entrapped by the mounting member and a point located along a length of the mounting member between the two opposing ends. The ring member may be equidistant from the opposing ends or arranged closer to one end relative to the opposing end.

Appositely, the mounting member comprises a toe. The toe provides a grasping point to hold the back surface of the panel once the mounting member is fully inserted into the aperture.

The mounting member may therefore have at least two independent points of contact with the back surface of the panel via the aperture. The toe may be arranged in opposition to a main body of the mounting member such that the toe and main body grasp opposing sides of the panel about the aperture thereby providing a secure attachment. The aperture may be sized such that once the majority of the mounting member (i.e. The main body) is inserted into the aperture, there is sufficient slack space to also allow the toe inside the aperture and then re-adjust the mounting member so the both the main body and toe are in engagement with the back surface of the panel.

Appropriately, the mounting member comprises a fixation arranged to receive a complementary fixation to secure the luggage ring assembly to a panel. Any suitable fixation may be used such as a bolt and threaded tube, rivet and aperture, expanding fixation, or the like.

Preferably, the fixation of the mounting member is a threaded tube arranged to receive a bolt, but any suitable arrangement may be acceptable, such as the alternative of the mounting member comprising a threaded bar to receive a nut with a complementary thread.

Suitably, the fixation is flush with a front face of the mounting member. In this way the fixation does not interfere with the location of the mounting member against the back surface of the panel.

Appositely, the fixation is flush with a back face of the mounting member. In this way, the mounting member may be made more compact and avoid forming a snag point which may catch cabling and the like. Such an arrangement may also simply manufacture via stamping.

Appropriately, the fixation is proud of a back face and/or of a front face of the mounting member. The fixation may, for example, stand proud of the front face of the mounting member. The front face being the face of the mounting member that meets and faces the back surface of the panel when inserted and fixed in place. A further aperture may be provided in the panel which is sized and placed in the panel relative to the aforementioned aperture in order to receive the proud fixation. The proud fixation therefore provides a locating and anti-rotation feature to hold the luggage ring assembly in position on the panel as the proud fixation would be captured by the further aperture. The luggage ring assembly may have any suitable arrangement of flush/proud fixation e.g. The fixation may be flush with the rear mounting member face but proud of the front mounting member face, the reverse, both proud, or both flush.

Suitably, the back face comprises a contoured surface such that a width of the mounting member is increased by the contoured surface in order to accommodate a width of the fixation.

Preferably, the mounting member comprises a seeking surface arranged to urge the luggage ring assembly into a seated position in an aperture of a panel. The seeking surface may be a ramp arranged and sized to capture the panel aperture into which the mounting member is inserted to locate and control the orientation of the mounting member relative to the panel. This helps installation of the luggage ring assembly to the panel.

The illustrated example aspect(s) relates to luggage rings, and in particular to luggage rings that are installed to a structure, such as, for example, a chassis of a vehicle, via a concealed fastener plate, thus, providing improved pulling strength, as well as, improved ease of use during installation.

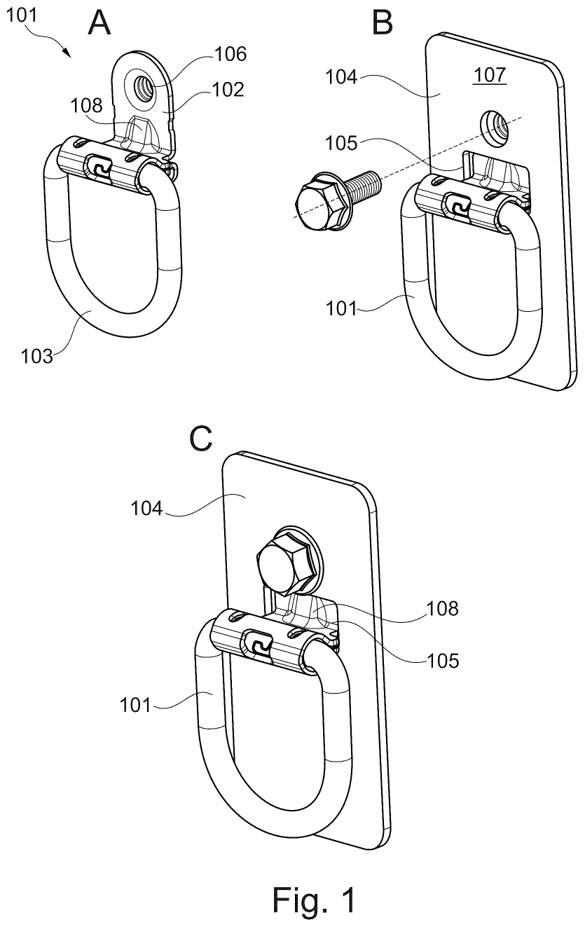

FIGS. 1(a), (b) and (c) shows a series of illustrations of the luggage ring assembly during installation to a substantially planar structure having a first aperture suitable to receive and push through the fastener plate of the luggage ring assembly. Once pushed through the first aperture and positioned into contact with a back surface of the panel structure, the thread member of the fastener plate is axially aligned with a second aperture, suitable to operably receive a threaded bolt, so as to tighteningly and securing engage with the thread member of the fastener plate of the luggage ring assembly.

FIG. 1(a) shows the luggage ring assembly 101 remote from the panel 104. The luggage ring assembly 101 has a ring member 103 which is intended for an end user to use as a securing point for luggage and the like within a vehicle. The ring member 103 is shown as a complete ring, but may instead be a hook or other suitably shaped securing member to allow a strop, rope, bungee cord or other connector to be securely fastened to the ring member 103. As such the ring member 103 is formed of any suitable material which is rated for the intended load of the luggage ring assembly 101, such as, but not limited to a metal including steel, stainless steel, titanium, reinforced polymers, wood, other natural or synthetic materials, etc.

The ring member 103 is attached to a mounting member 102. The attachment shown is by forming the mounting member 102 about the ring member 103, although any other suitable attachment may be used provided that the ring member 103 is secured to the mounting member 102 sufficiently to form its load bearing function. Preferably, the attachment allows limited movement of the ring member 103 relative to the mounting member 102 to allow for the ring member 103 to be rotated or otherwise moved to a convenient orientation for a load to be secured to the ring member 103. The mounting member 102 is formed of any suitable material in order for the mounting member 102 to carry out its function of securing the ring member 103 to a panel 104 and bear a rated load. Suitable materials include metals, such as steel.

The mounting member 102 comprises further features such as, but not limited to a fixation 106 which allows the mounting member 102 to be secured to a panel 104 such that the position of the mounting member 102 relative to the panel 104 may be fixed. The fixation 106 may allow for reversible attachment of the mounting member 102 to the panel 104 for maintenance or replacement. An example fixation 106 is shown as a threaded tube to which a like threaded bolt may be inserted.

The mounting member 102 also comprises a seeking surface 108 which urges the luggage ring assembly into a seated position in an aperture of a panel 104. The seeking surface may be a ramp arranged and sized to capture the panel aperture into which the mounting member is inserted to locate and control the orientation of the mounting member relative to the panel. This helps installation of the luggage ring assembly to the panel.

FIG. 1(b) shows a semi-fixed luggage ring assembly 101 inserted into an aperture 105 of a panel 104. The front surface 107 of the panel 104 obscures the mounting member 102 of the luggage ring assembly 101 from the view of an end user.

A second aperture is provided in the front surface 107 which is in alignment with the fixation 106 allowing a bolt or other complementary/compatible fixation to be inserted and secured to the fixation 106 of the luggage ring assembly 101.

This is shown in FIG. 1(c) with the luggage ring assembly 101 in a fixed position on the panel 104. The seeking surface 108 urges the seeking surface 108 into a predetermined arrangement with the aperture 105 via a ramped surface, although this could be achieved with other topology, such as multiple lugs or locating features.

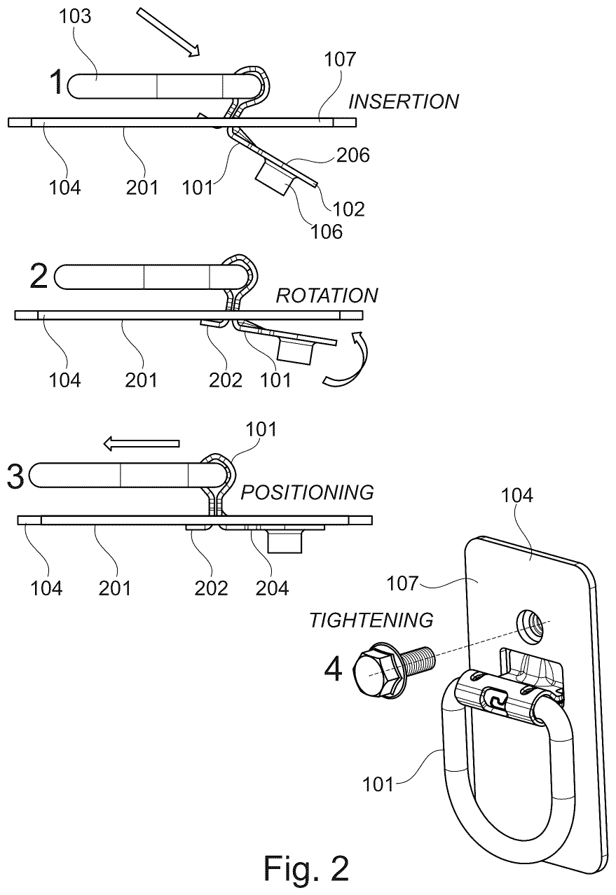

A detailed illustration of the series of installation and fastening steps (1), (2), (3) and (4) are further shown in FIG. 2. Like reference numerals are used to show common features with FIG. 1 and to avoid unnecessary repetition. Here, the mounting member 102 of the luggage ring assembly 101 is first pushed through the first aperture 105 of the panel 104 and rotated behind the panel 104 structure so as to parallelly and contactingly engage the mounting member 102 with the back surface 201 of the panel 104 structure. In that position, the mounting member 102 can be moved back (via e.g. A sliding movement), so that the proximal end portion of the mounting member 102 contactingly engages with the back surface 201 of the panel structure, thus, fully engaging the panel structure on opposing sides of the first aperture 105 (e.g. Via a toe 202). In this case a front face 206 of the mounting member 102 contacts the back surface 201 of the panel 104. A back face 204 of the mounting member 102 is arranged opposite the front face 206 and does not engage with the back surface 201 of the panel 104.

Once in place, the thread member (fixation 106) of the mounting member 102 is axially aligned with the second aperture (bolt aperture) in the panel 104, allowing a threaded bolt or other complementary fixation to engage with the thread member through the second aperture and fasten the luggage ring assembly 101 into position on the panel 104 structure. It is understood by the person skilled in the art, that the bolt is only used to fix the mounting member 102 into position so as to prevent lateral movement along the panel structure, it does not add to the pulling strength of the luggage ring, which is provided by the contact engagement of opposing end portions of the mounting member 102 with the back surface 201 of the panel structure.

Therefore, the luggage ring assembly 101 provides improved performance and robustness due to a large retention surface behind the panel structure, reducing potential forces acting on the screw or bolt during use, thus, allowing the use of smaller screws or bolts.

Furthermore, the luggage ring assembly provides an improved case of use, allowing easier assembly and disassembly. In this particular example, the first aperture is of rectangular shape, thus, preventing possible rotation of the luggage ring (serving as an anti-rotation system). In addition, the luggage ring assembly of the present disclosure minimizes the number of parts required for installation, as no-weld nuts are required on the panel structure or potential reinforcement backing plates (in some cases). Further, the luggage ring assembly may provide minimized weight due to reduction of screw or bolt sizes and less parts.

To provide for the luggage ring assembly, there is no welding required, simply a rectangular and circular aperture suitable to receive the fastener plate and to align with a bolt.

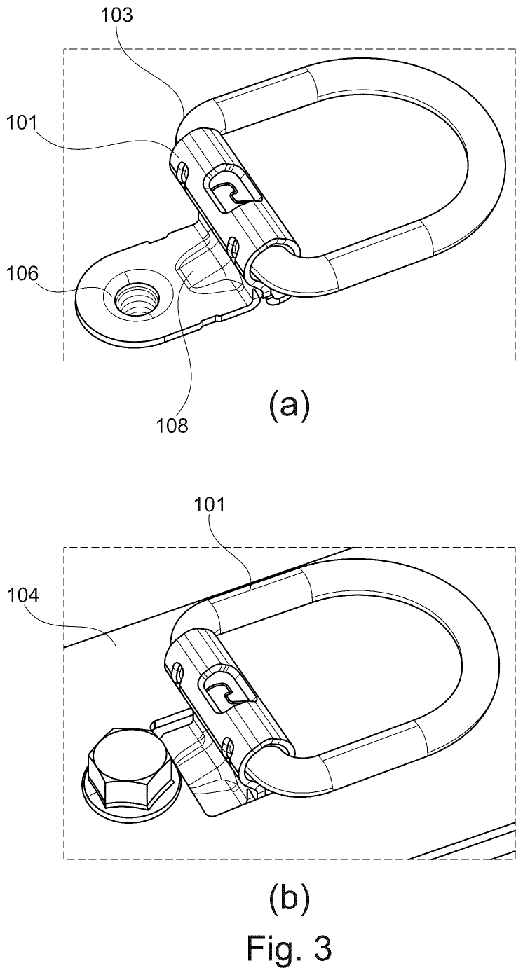

A further two views of the luggage ring assembly 101 are shown in FIG. 3 in (a) on its own and in (b) where the luggage ring assembly 101 is attached to the panel 104. Like reference numerals are used to avoid unnecessary repetition.

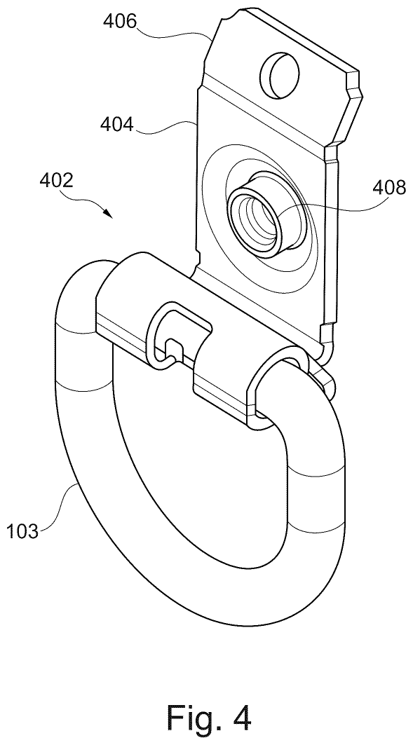

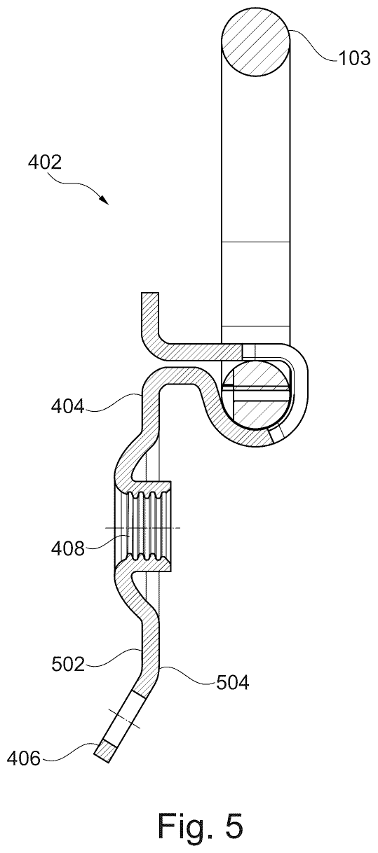

FIG. 4 and FIG. 5 show an alternative luggage ring assembly 402 which shares many similar features to the luggage ring assembly 101. These are provided with like numerals and share the same features so as to avoid unnecessary repetition. The luggage ring assembly 402 principally differs in having a differently shaped mounting member 404 which, while similar to the mounting member 102 of previous figures, instead has the fixation 408 located on the front face 206, 504 of the mounting member 404 (although it is through-going in the mounting member 404. This is to make the mounting member 404 relatively more compact compared to the mounting member 102 of previous figures. Arranging the fixation 408 on the front face 206, 504 also ensures that the fixation 408 is trapped between the front surface 107 of the panel 104 and the mounting member 404 when in place, therefore removing a potential snag point. The back face 502 is arranged in opposition to the front face 504 similar to the back face 204 and front face 206 of the mounting member 102 in earlier figures.

The mounting member 404 is also provided with a bent portion 406. The bent portion provides a locating feature to assist in insertion of the mounting member into the aperture 105 of the panel 104 by an operative. In use the bent portion is arranged such that a maximum deviation of the bent portion from the main portion of the mounting member is closest to the panel and therefore the aperture, allowing the bent portion to be easily captured by the aperture. The bent portion may be bent such that the bent portion stands proud of the back face of the mounting member.

The bent portion 406 is arranged remote from the ring member 103. Arranging the bent portion remote from the ring member means an installation operative may grasp the ring member as a handle to guide the mounting member into place via the bent portion.

FIG. 5 shows a cross-sectional view of the luggage ring assembly 402 of FIG. 4. As such the bend of the bent portion 406 is visible with the bent portion 406 deviating in the direction of the back face 502 away from the front face 504.

Furthermore, it can be seen how the fixation 408 is arranged proud of the front face 504 of the mounting member 404 in this non-limiting example. The front face 504 being the face of the mounting member 404 that meets and faces the back surface of the panel 104 when inserted and fixed in place. A further aperture may be provided in the panel 104 which is sized and placed in the panel relative to the main aperture 105 in order to receive the proud fixation 408. The proud fixation therefore provides a locating and anti-rotation feature to hold the luggage ring assembly 402 in position on the panel as the proud fixation would be captured by the further aperture. The luggage ring assembly may have any suitable arrangement of flush/proud fixation e.g. The fixation may be flush with the rear mounting member face but proud of the front mounting member face, the reverse, both proud, or both flush.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A luggage ring assembly comprising a concealable mounting member and a ring member wherein said mounting member is adapted to operably engage with a back surface of a panel through at least one aperture, adapted to receive said mounting member.

2. The luggage ring assembly of claim 1 wherein the mounting member is formed in a single piece.

3. The luggage ring assembly of claim 1, wherein the mounting member is formed from a pressed material.

4. The luggage ring assembly of claim 1, wherein the ring member is held by the mounting member.

5. The luggage ring assembly of claim 1, wherein the mounting member comprises a bent portion.

6. The luggage ring assembly of claim 5, wherein the bent portion is arranged remote from the ring member.

7. The luggage ring assembly of claim 1, wherein the ring member is held by the mounting member between opposing ends of the mounting member.

8. The luggage ring assembly of claim 1, wherein the mounting member comprises a toe.

9. The luggage ring assembly of claim 1, wherein the mounting member comprises a fixation arranged to receive a complementary fixation to secure the luggage ring assembly to a panel.

10. The luggage ring assembly of claim 9 wherein the fixation is a threaded tube.

11. The luggage ring assembly of claim 9, wherein the fixation is flush with a front face of the mounting member.

12. The luggage ring assembly of claim 9, wherein the fixation is flush with a back face of the mounting member.

13. The luggage ring assembly of claim 9, wherein the fixation is proud of a back face and/or of a front face of the mounting member.

14. The luggage ring assembly of claim 5, wherein the bent portion is bent such that the bent portion stands proud of the back face of the mounting member.

15. The luggage ring assembly of claim 1, wherein the back face comprises a contoured surface.

16. The luggage ring assembly of claim 1, wherein the mounting member comprises a seeking surface arranged to urge the luggage ring assembly into a seated position in an aperture of a panel.
